(19) United States
(12) Patent Application Publication
(10) Pub. No.: US 2017/0203939 A1
(43) Pub. Date: Jul. 20, 2017

(54) WINCH FOR A TENSION LINE

(71) Applicant: J. Schmalz GmbH, Glatten (DE)

(72) Inventors: Andreas Hamann, Dornstetten (DE); Jonas Mast, Baiersbronn (DE); Andreas Steinbach, Dornstetten (DE)

(73) Assignee: J. Schmalz GmbH, Glatten (DE)

(21) Appl. No.: 15/402,139

(22) Filed: Jan. 9, 2017

(30) Foreign Application Priority Data
Jan. 19, 2016 (DE) 10 2016 100 783.8

(51) Int. Cl. B66D 1/39

(52) U.S. Cl. CPC B66D 1/39; B66D 2700/0191; B66D 2700/0141

(57) ABSTRACT

A winch for winding and unwinding of a tension line, with a winding drum that is rotational around its central axis so that the tension line is windable and unwindable in windings running around the winding drum, and with a rotating actuator for driving a rotation of the winding drum, wherein the winding drum is arranged in a longitudinally movable manner along its central axis with respect to a base of the winch. It is a threaded rod extending in the central axis and having an external thread, wherein the winding drum is arranged rotationally around the threaded rod by means of a counter-thread that engages in the external thread.

The invention refers to a winch with an axially displaceable winding drum according to the preamble of claim 1.

Such winches are used e.g. in lifting cranes with a carrying cable, wherein the carrying cable on the one hand is connectible to a load, for example by means of a support device, and on the other hand is windable by means of a winch arranged at a scaffold for lifting the load.

With such winches it will be advantageous if the tension line can be wound on the winding drum in an orderly manner, particularly in such a manner that the tension line runs in parallel windings running alongside one another around the winding drum and, if applicable, several layers of windings are wound orderly on top of each other.

In this regard, various devices are known, in which a cable is run to the winding drum via a guiding device, wherein the guiding device is moved axially along the winding drum when rotating the winding drum. In this process, the guided cable applies transverse forces on the guiding device. This may cause occurrence of undesired wear of parts rubbing each other and the need for an increased amount of energy for operation. Abrasion material and other impurities may collect at the guiding devices, which may require regular maintenance efforts.

Moreover, devices are known in which the rotationally driven winding drum is moved axially when rotating for winding cable windings next to each other. DE 1 053 757 B shows a cable winch with the characteristics of the preamble of claim 1. A cable drum is provided, being allocated in an axially displaceable manner on a central square shaft. The square shaft forms the axis of rotation and acts as drive actuator for rotating the cable drum. A concentric cam disk resting at a control cam is connected to the cable drum. A curve contour of the cam disk pressing against the control cam moves the cable drum back and forth and winds the cable layer by layer. Another generic device is described in DE 732045 C. Here, a cable drum is arranged in a rotational and axially movable manner around a central drive shaft. Driving rods running in parallel to the shaft, bearing the cable drum and rotationally driving the cable drum when turning the drive shaft, are provided for the central shaft. One of the eccentric driving rods has an outer thread for axial relocation of the cable drum. This is run in threaded sleeves arranged at the cable drum. The rod with the external thread rotates around the drive shaft and is rotated by a planetary gear. If the drum rotates, the threaded sleeves are running along the external thread, relocating the cable drum along the rod. Such solutions make use of various components and gear systems that are movable against one another, possibly resulting in design and adjustment efforts.

The invention is based on the task to provide a reliable, resilient and relatively simply-constructed winch enabling orderly winding and unwinding of the tension line.

This task is solved using a winch according to claim 1. The winch is used for winding and unwinding of a tension line having flexible design and being windable in the present context (e.g. a cable, a chain or a belt). The winch has a winding drum that is rotational around its central axis. When rotating the winding drum, the tension line is wound or unwound in windings running around the winding drum. A rotating actuator engaging at the winding drum is provided for driving rotation of the winding drum. The winding drum is positioned so that it can be moved longitudinally along its central axis. In this respect, the longitudinal movement is made with respect to a locally fixed reference, e.g. a fixed base of the winch.

According to the invention, a threaded rod is provided, extending so that the central axis of the winding drum extends within the threaded rod. The threaded rod has an external thread. The winding drum runs by means of a counter-thread on the external thread of the threaded rod. Thus, when rotating the winding drum, the counter-thread turns around the external thread, and the rotation movement of the winding drum is coupled to a translation movement along the threaded rod. This makes it possible to wind and unwind the tension line in windings orderly placed next to each other. This does not necessarily require a relocatable guide for setting the windings. In this respect, the tension line can be lead to the winch at a fixed feed and/or outlet position. This may reduce wear of the tension line and other movable parts. Thereby, the axial relocation of the winding drum is made particularly without additional gear systems, reducing the design and maintenance efforts. Altogether, this enables a resilient and compact design.

Preferably, the rotating actuator has at least one driving shaft extending parallel to the central axis and arranged eccentrically, i.e. with radial offset, to the central axis. The driving shaft is drivable on a circular path around the central axis and acts together with the winding drum. As the driving shaft is eccentric to the central axis, a torque regarding the central axis can be transferred to the winding drum.

The rotating actuator preferably comprises a rotationally drivable actuator base part, e.g., a base disk. The actuator base part particularly comprises a central pivot bearing, supporting an end of the threaded rod so that the actuator base part is rotational around the central axis. In this respect, the central axis runs through the pivot bearing. This enables a particularly compact design as the rotational actuator base part simultaneously provides the end bearing for the (particularly non-rotational) threaded rod. The actuator base part can have e.g. a flange by way of which a connection to a drive shaft of a rotary drive is made.

In particular, the at least one driving shaft on the actuator base part is arranged eccentrically offset with respect to the central pivot bearing. The driving shaft can be arranged at a fixed position in the actuator base part, e.g. it can be fixed in a recess of the actuator base part. However, the driving shaft can also be positioned rotationally in the actuator base part.

It is particularly preferred that the rotating actuator comprises several driving shafts of the stated type, arranged in a symmetric arrangement eccentrically around the central axis (and particularly around the stated central pivot bearing). Particularly, two driving shafts are provided, arranged opposite with respect to the central axis (or with respect to the central pivot bearing, if provided).

Particularly, it is provided that the threaded rod does not rotate when the winding drum rotates. In this respect, for example, one end of the threaded rod can be fixed in a non-rotational manner at one base of the winch. Preferably, the threaded rod is arranged in a completely immovable manner in the winch.

The base of the winch can be, e.g., a base part with a base flange by way of which the winch is attachable to a superior device.

According to an advantageous embodiment, the winding drum has a bearing in which the driving shaft is supported in a longitudinally displaceable manner (i.e., displaceable in directions parallel to the central axis). The bearing allows for axial movement of the winding drum along the central axis and along the driving shaft, so that it can be rotationally driven irrespective of its axial position. Particularly, the bearing is arranged eccentrically with respect to the central axis. Preferably, the bearing is designed both as linear bearing (sliding bearing) and as pivot bearing so that tilting is avoided when rotating the winding drum.

In another embodiment, the winding drum can have a carrier part with a central duct for the threaded rod. The duct coaxially surrounds the central axis. The carrier part also can have a drive section, where the rotating actuator engages for driving the winding drum, arranged eccentrically with respect to the central duct. Particularly, the drive section includes the bearing for the stated driving shaft.

Advantageously, the counter-thread can be formed by an internal thread in the central duct of the carrier part so that only few components are needed. Particularly, the internal thread coaxially surrounds the central axis (and also the threaded rod). Easy assembly also can be performed by fitting a threaded sleeve with an internal thread into the central duct.

In an advantageous embodiment the external thread is formed as cross-threading having two counter-rotating thread profiles. Consequently, the winding drum driven in a defined direction runs back and forth along the threaded rod. This makes it possible to wind the windings of the tension line in subsequent layers on top of each other.

Particularly, the two counter-rotating thread profiles are connected to each other in their end sections. In this respect, the two thread profiles merge into each other in their end sections, respectively, and create reversal points of the cross-thread. Correspondingly, the rotating winding drum runs back and forth along the external thread.

The winch can be adapted for various purposes by means of the geometric design of the external thread and/or of the counter-thread. Thus, it can be provided that the pitch of the external thread and/or of the counter-thread corresponds to a preset and/or desired spacing of the windings. The spacing represents the distance used for winding the tension line on the winding drum. For example, the pitch can correspond to a thickness of the tension line. Correspondingly, the windings are positioned directly next to each other.

In a further embodiment the winding drum has an external winding surface. This can be mainly cylindrical. Particularly, the winding surface has a helically surrounding surface groove used for guiding windings for the tension line and for orderly placement of windings on the winding surface. Correspondingly, the tension line is wound and unwound in a defined manner.

In the following the invention is further explained by means of the figures showing:

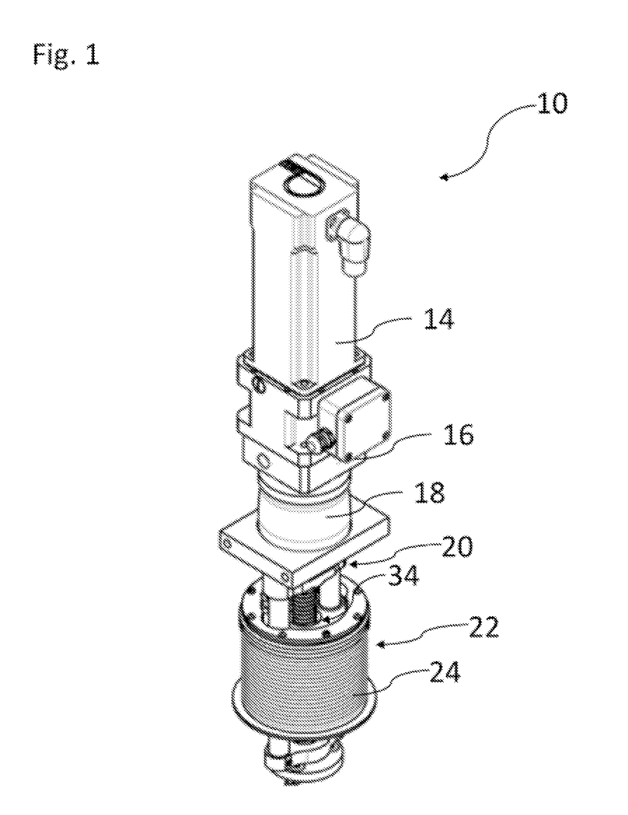

FIG. 1: External perspective view of an inventive winch;

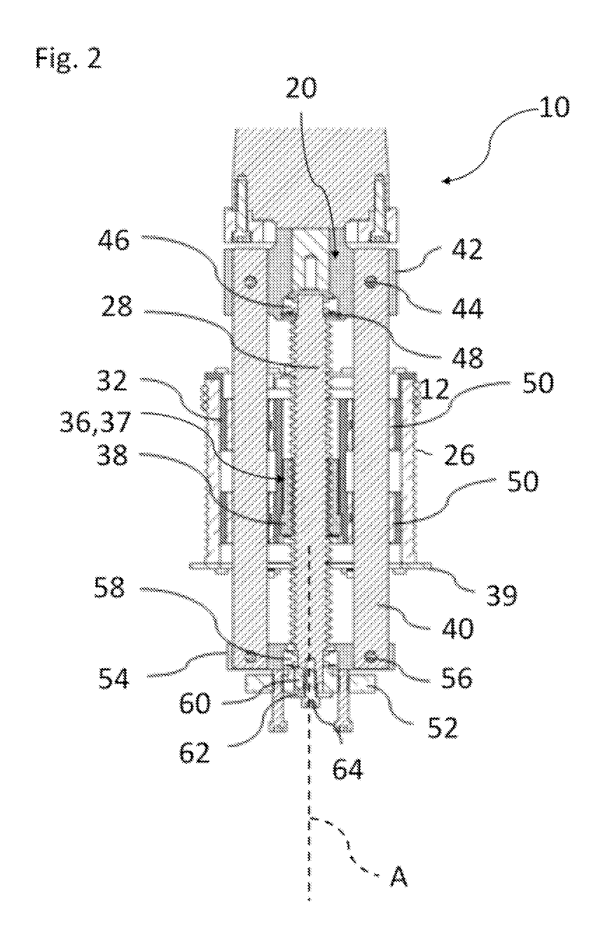

FIG. 2: Longitudinal cross section for explanation of the winch according to FIG. 1;

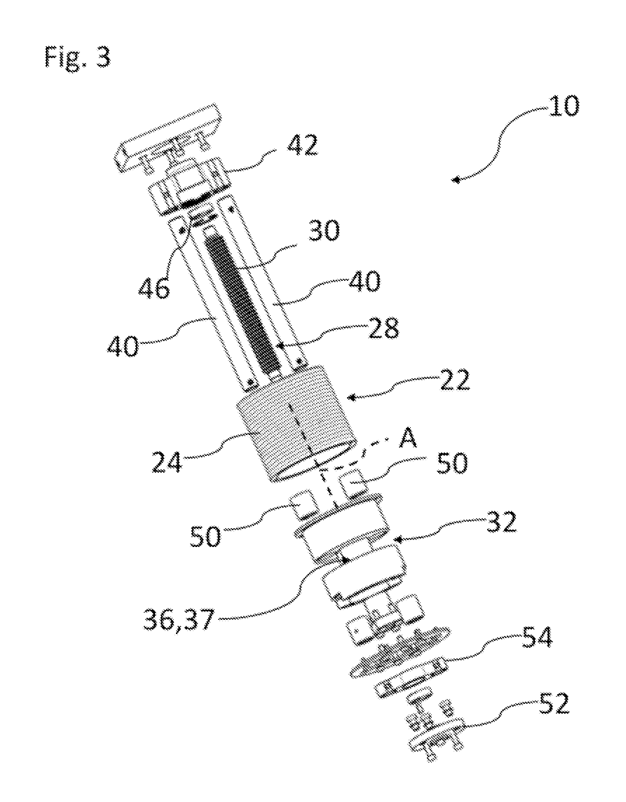

FIG. 3: Exploded view for explanation of the winch according to FIGS. 1 and 2.

The following description as well as the figures use the same reference numerals for identical or mutually corresponding features.

The FIGS. 1-3 show a winch 10 for winding and unwinding of a tension line 12 (here: a cable) schematically represented in the longitudinal cross section of FIG. 2. The winding drum 10 comprises a rotary drive 14 (for example electric motor) optionally connected to a rotating actuator 20 via further units (for example braking device 16 and/or gearing 18).

The rotating actuator 20 is arranged to drive a winding drum 22 for rotation around its central axis A. The winding drum 22 has a cylindrical, external winding surface 24 that can have at least one helically surrounding surface groove 26 (see FIG. 2).

A threaded rod 28 having an external thread 30 (see FIG. 3) extends along the central axis A.

The winding drum 22 comprises a carrier part 32 with a central duct 34 through which the threaded rod 28 runs. The central duct 34 has a counter-thread 36 running on the external thread 30 of the threaded rod 28. The counter-thread 36 can be formed e.g. by an internal thread 37 of a threaded sleeve 38 fitted e.g. into the carrier part 32. Basically, the winding drum 22 can be composed of several parts and e.g. can be screwed to a final flanged disk 39.

The carrier part 32 has a drive section (at reference numeral 50) arranged eccentrically with respect to the central duct 34 (i.e. radially offset with respect to the central axis A) and operated by the rotating actuator 20 for rotational driving of the winding drum 22.

The rotating actuator 20 can comprise e.g. two driving shafts 40 symmetrically arranged at an actuator base part 42 with respect to the central axis and fixed e.g. by means of a locking pin 44.

The actuator base part 42 has a central pivot bearing 46, where the threaded rod 28 is rotationally supported. For example, the pivot bearing 46 is designed as ball bearing and can be secured with a locking ring 48.

The driving shafts 40 extend through the corresponding ducts in the drive section of the carrier part 32 and can be displaced there longitudinally in bearings 50 and, preferably, are supported rotationally.

The end of the threaded by 28 opposite to the pivot bearing 46 is fixed in a base 52 of the winch 10. The base can be provided by a fastening flange for external fixing of the winch. The ends of the driving shaft 40 opposite to the actuator base part 42 are housed in a base disk 54 and are locked e.g. by means of pins 56. In turn, the base disk 54 has a central pivot bearing 58 (e.g. ball bearing) through which the threaded rod 28 runs so that rotation around such rod is possible. The threaded rod 28 can be rotation-locked by means of a feather key 60 (e.g. with disk 62 and screw 64) in the base 52. The position of the threaded rod 28 along the central axis A can be set by removing and, if applicable, replacing the feather key 60.

1. A winch for winding and unwinding of a tension line, with a winding drum that is rotational around its central axis so that the tension line, is windable and unwindable in windings running around the winding drum, and with a rotating actuator for driving a rotation of the winding drum, wherein the winding drum is arranged in a longitudinally movable manner along its central axis with respect to a base of the winch,
wherein a threaded rod extending in the central axis and having an external thread is provided, and
wherein the winding drum is arranged rotationally around the threaded rod by means of a counter-thread that engages in the external thread.

2. The winch according to claim 1, wherein the rotating actuator has at least one driving shaft extending parallel to the central axis and arranged eccentrically with respect to the central axis.

3. The winch according to claim 2, wherein the rotating actuator includes a rotationally drivable actuator base part with a pivot bearing, in which one end of the threaded rod is supported rotationally.

4. The winch according to claim 3, wherein at least one driving shaft on the actuator base part is arranged offset with respect to the pivot bearing.

5. The winch according to claim 4, wherein one end of the threaded rod is fixed in a non-rotational manner at the base of the winch.

6. The winch according to claim 2, wherein the winding drum includes a bearing, in which the at least one driving shaft is supported in a longitudinally displaceable manner.

7. The winch according to claim 6, wherein the winding drum includes a carrier part with a central duct for the threaded rod, wherein the carrier part has a drive section at an offset position with respect to the central duct and operated by the rotating actuator for driving the winding drum.

8. The winch according to claim 7, wherein the central duct includes an internal thread forming the counter-thread.

9. The winch according to claim 8, wherein the external thread is formed as cross-threading having two counter-rotating thread profiles.

10. The winch according to claim 9, wherein the pitch of the external thread and/or of the counter-thread corresponds to a preset spacing of the windings.
